(19) United States
(12) Patent Application Publication
(10) Pub. No.: US 2018/0260855 A1
(43) Pub. Date: Sep. 13, 2018

(54) METHOD AND DEVICE FOR PUSHING PROMOTION INFORMATION

(71) Applicant: BEIJING KINGSOFT INTERNET SECURITY SOFTWARE CO., LTD., BEIJING (CN)

(72) Inventor: Hangzhong YU, BEIJING (CN)

(21) Appl. No.: 15/760,842

(22) PCT Filed: Aug. 15, 2016
(86) PCT No.: PCT/CN2016/095332

§ 371 Date: Mar. 16, 2018

(30) Foreign Application Priority Data
Sep. 24, 2015 (CN) 201510617575.2

(51) Int. Cl. G06Q 30/02; H04L 29/08

(52) U.S. Cl. CPC G06Q 30/0269; G06Q 30/0267; H04L 67/26; H04L 67/306

(57) ABSTRACT

The present disclosure provides a method and a device for pushing promotion information. The method includes: obtaining user behavior data of a user using the terminal; analyzing obtained user behavior data, to obtain behavior information of the user and/or behavior access object information of the user; determining an information type of obtained behavior information of the user and/or behavior access object information of the user; searching for promotion information corresponding to determined information type in a promotion information base stored in the terminal; and pushing found promotion information to the user.

### CROSS-REFERENCE TO RELATED APPLICATION

This application is based on and claims priority and benefits of Chinese Patent Application Serial No. 201510617575.2, filed with the State Intellectual Property Office of P.R. China on Sep. 24, 2015, the entire content of which is incorporated herein by reference.

### FIELD

The present disclosure relates to a computer technology field, and more particularly to a method and a device for pushing promotion information.

### BACKGROUND

With rapid development of internes technology, users perform various network activities such as chatting, playing games, and shopping via terminals such as a mobile phone and a computer. The terminal can actively push some promotion information to the user, such as an advertisement of a product.

A method for pushing the promotion information in the related art is as follows. A server firstly determines promotion information to be pushed to the user, and then sends the determined promotion information to respective terminals uniformly, such that the respective terminals push the received promotion information to the users.

This method has some disadvantages. The server determines the promotion information to be pushed and sends it to respective terminals uniformly, such that the promotion information received by respective terminals is the same, and the promotion information pushed to different users by respective terminals is also the same. However, for the users, user personalization varies greatly, and thus the promotion information pushed to a user by a terminal may not be what the user is interested in. In this way, the meaning of pushing is lost, and unrelated promotion information may cause too much trouble to the user.

### SUMMARY

An objective of embodiments of the present disclosure is to provide a method and a device for pushing promotion information, such that promotion information that a user may be interest in is pushed to the user, avoiding troubling the user too much due to unrelated promotion information. The technical solutions are as follows.

A method for pushing promotion information, applied to a terminal, includes: obtaining user behavior data of a user using the terminal; analyzing obtained user behavior data, to obtain behavior information of the user and/or behavior access object information of the user; determining an information type of obtained behavior information of the user and/or behavior access object information of the user; searching for promotion information corresponding to determined information type in a promotion information base stored in the terminal; and pushing found promotion information to the user.

In an embodiment of the present disclosure, when there are at least two pieces of found promotion information corresponding to the determined information type, pushing found promotion information to the user includes: pushing the found promotion information in sequence to the user according to an order of priority from high to low; or, pushing the found promotion information having a highest priority to the user.

In an embodiment of the present disclosure, the method further includes: sending an update request with respect to promotion information to a server according to a preset period; and receiving addition and deletion information related to promotion information returned by the server, and updating the promotion information base.

In an embodiment of the present disclosure, the method further includes: receiving addition and deletion information related to promotion information sent from a server, and updating the promotion information base.

In an embodiment of the present disclosure, after pushing found promotion information to the user, the method further includes: receiving a viewing operation on the pushed promotion information of the user; and adjusting priorities of promotion information in the promotion information base according to the number of viewing times of promotion information of each information type.

A device for pushing promotion information, applied to a terminal, includes: a user behavior data obtaining module, configured to obtain user behavior data of a user using the terminal; a behavior related information obtaining module, configured to analyze obtained user behavior data, to obtain behavior information of the user and/or behavior access object information of the user; an information type determining module, configured to determine an information type of obtained behavior information of the user and/or behavior access object information of the user; a promotion information searching module, configured to search for promotion information corresponding to determined information type in a promotion information base stored in the terminal; and a promotion information pushing module, configured to push found promotion information to the user.

In an embodiment of the present disclosure, the promotion information pushing module is configured to: in a case that there are at least two pieces of found promotion information corresponding to the determined information type, push the found promotion information in sequence to the user according to an order of priority from high to low; or, push the found promotion information having a highest priority to the user.

In an embodiment of the present disclosure, the device further includes: a first promotion information base updating module, configured to send an update request for promotion information to a server according to a preset period; to receive addition and deletion information related to promotion information returned by the server, and to update the promotion information base.

In an embodiment of the present disclosure, the device further includes: a second promotion information base updating module, configured to receive addition and deletion information related to promotion information sent from a server, and to update the promotion information base.

In an embodiment of the present disclosure, the device further includes: a priority adjusting module, configured to receive a viewing operation on the pushed promotion information of the user, and to adjust priorities of promotion information in the promotion information base according to the number of viewing times of promotion information of each information type.

A terminal includes a processor and a memory configured to store instructions executable by the processor. The processor is configured to: obtain user behavior data of a user using the terminal; analyze obtained user behavior data, to obtain behavior information of the user and/or behavior access object information of the user; determine an information type of obtained behavior information of the user and/or behavior access object information of the user; search for promotion information corresponding to determined information type in a promotion information base stored in the terminal; and push found promotion information to the user.

A computer-readable storage medium has stored therein instructions that, when executed by a processor of a terminal, cause the terminal to perform the above-mentioned method for pushing promotion information.

A computer program, when running on a processor, performs the above-mentioned method for pushing promotion information.

With the technical solutions provided by embodiments of the present disclosure, the promotion information base is locally stored in the terminal, and after the terminal obtains the user behavior data, the terminal analyzes the user behavior data to obtain the behavior information of the user and/or the behavior access object information of the user, determines the information type of the obtained information, and searches for the promotion information corresponding to the determined information type in the promotion information base stored in the terminal and pushes the found promotion information to the user. In this way, the promotion information pushed to the user is related to the user behavior, and may be of interest to the user, avoiding troubling the user too much due to unrelated promotion information. In addition, the technical solutions provided by embodiments of the present disclosure are performed in the terminal without information transmission with a server, which can protect privacy of the user, save network bandwidth, and reduce network flow.

### BRIEF DESCRIPTION OF THE DRAWINGS

In order to explicitly illustrate technical solutions in embodiments of the present disclosure, a brief introduction for the accompanying drawings used when describing the embodiments will be listed as follows. Apparently, the drawings described below are only corresponding to some embodiments of the present disclosure, and those skilled in the art may obtain other drawings according to these drawings without creative labor.

FIG. 1 is a flow chart of a method for pushing promotion information according to an embodiment of the present disclosure;

FIG. 2 is a block diagram illustrating a device for pushing promotion information according to an embodiment of the present disclosure;

FIG. 3 is a block diagram illustrating a terminal according to an embodiment of the present disclosure.

### DETAILED DESCRIPTION

In order to explicitly illustrate technical solutions in embodiments of the present disclosure, the technical solutions in the embodiments of the present disclosure will be described clearly and completely in connection with the drawings in the embodiments of the present disclosure as follows. Apparently, the described embodiments are only part of embodiments of the present disclosure, instead of the entire embodiments. Based on embodiments described herein, those skilled in the art may obtain all other embodiments without creative labor, which belongs to the protection scope of the present disclosure.

The technical solutions provided in embodiments of the present disclosure are applied to a terminal. The terminal includes but is not limited to a mobile phone, a tablet computer, a desktop computer, a smart bracelet, and the like.

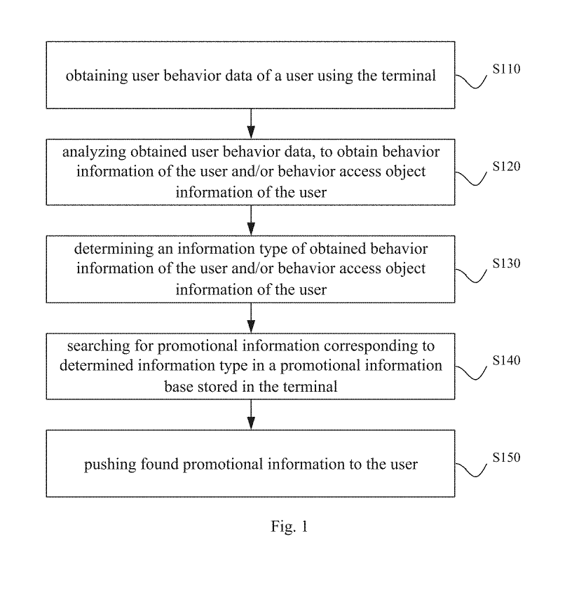

Referring to FIG. 1, which is a flow chart of a method for pushing promotion information according to an embodiment of the present disclosure, the method may include followings.

At block S110, user behavior data of a user using the terminal is obtained.

With the rapid development of the terminal technology, various terminals gradually emerge, such as a mobile phone, a tablet computer, a desktop computer, a smart bracelet, and the like. The user can use the mobile phone, the tablet computer, the desktop computer, and other terminals to perform operations such as network browsing, online shopping, photo browsing, and video viewing, and generate corresponding user behavior data. Exercise behavior data may be generated when the user uses the smart bracelet.

The terminal can obtain current user behavior data of the user using the terminal. For example, if the user is browsing photos in the mobile phone currently, the terminal can obtain current photo browsing behavior data of the user.

The terminal can also obtain user behavior data of the user using the terminal in a preset period. For example, the terminal can obtain online shopping behavior data of the user in the past one month before the current time.

At block S120, obtained user behavior data is analyzed, to obtain behavior information of the user and/or behavior access object information of the user.

The user behavior data is obtained at block S110. The terminal can analyze the obtained user behavior data to obtain the behavior information of the user and/or the behavior access object information of the user.

Some simple examples are given to facilitate understanding.

The online shopping behavior data of the user is analyzed to obtain information of products bought by the user, information of products browsed by the user, and the like.

The photo browsing behavior data of the user is analyzed to obtain information of photos browsed by the user, such as whether the photo browsed by the user being a figure photo or a home environment photo.

The exercise behavior data of the user is analyzed to obtain exercise behavior information of the user, such as whether the user being good at running or being good at keeping fit.

It should be noted that, only the behavior information of the user may be obtained, or only the behavior access object information of the user may be obtained, or both the behavior information of the user and the behavior access object information of the user may be obtained, when terminals of different types are used to analyze the user behavior data. Analyzing the user behavior data is a known technology in the related art, which is not limited in embodiments of the present disclosure.

At block S130, an information type of obtained behavior information of the user and/or behavior access object information of the user is determined.

By classifying the behavior information of the user and/or the behavior access object information of the user obtained at block S120, the information type of the obtained information can be determined.

The information type is an information type included in a promotion information base locally stored in the terminal. The determined information type may include one or more of information types of the promotion information included in the promotion information base locally stored in the terminal.

For example, the information type may be a cosmetic type, a home building material type, a smart terminal type, a fitness equipment type, and the like. When the obtained behavior access object information of the user is information of furniture in the home environment photo, or when the obtained behavior access object information of the user is information of furniture bought from a shopping site by the user, the information type corresponding to the information of furniture may be determined as the home building material type. When the obtained behavior access object information of the user is skin color information in the figure photo, the information type corresponding to the skin color information may be determined as the cosmetic type. When the obtained behavior information of the user is fitness behavior information, the information type corresponding to the fitness behavior information may be the determined as the fitness equipment type.

Certainly, embodiments of the present are not limited to above-described several information types.

At block S140, a promotion information base stored in the terminal is searched for promotion information corresponding to determined information type.

The terminal may store one promotion information base. A plurality of pieces of promotion information of various information types is stored in the promotion information base. After the information type of information related to the obtained behavior access object of the user is determined, the terminal may search for the promotion information corresponding to the determined information type in the promotion information base stored in the terminal. For example, the information type determined at block S130 is the cosmetic type, the terminal searches for promotion information corresponding to the cosmetic type in the promotion information base, such as promotion information of moisturizing cream of a certain brand, or promotion information of whitening cream of a certain brand. For another example, the information type determined at block S130 is the home building material type, the terminal searches for promotion information corresponding to the home building material type in the promotion information base, such as promotion information of sofa of a certain brand, or promotion information of wall paint of a certain brand.

The promotion information in the promotion information base stored in the terminal may be obtained by the terminal from the server. In actual application, operations personnel can update promotion information in the server. In a communication process between the server and the terminal, the server sends the updated promotion information to the terminal in time, such that the terminal can search for the promotion information to be pushed to the user in the promotion information base stored locally.

It should be understood that, the promotion information base is not changeless. However, some promotion information may be added to the promotion information base, or some promotion information in the promotion information base may be invalid because it reaches its time limit. Thus, the terminal needs to update the promotion information base saved by itself.

In detail, the terminal may update the promotion information base saved by itself as follows.

In a first step, an update request with respect to promotion information is sent to the server according to a preset period.

In a second step, addition and deletion information related to promotion information returned by the server is received, and the promotion information base is updated.

The terminal may send the update request with respect to promotion information to the server according to the preset period, such as every day or every week. The so-called update includes both addition and deletion. After the server receives the update request, the server detects whether there is changed promotion information. If yes, the detected addition and deletion information related to promotion information is returned to the terminal. The terminal updates the locally saved promotion information base after receiving the addition and deletion information related to promotion information. If the server does not detect changed promotion information, the server returns a response to the terminal, representing that there is no changed promotion information. In another embodiment, if the terminal does not receive any information returned from the server in a preset period after the terminal sends the update request, the terminal may determine that there is no changed promotion information currently.

In this way, in each preset period, the terminal can perform one communication with the server to obtain the addition and deletion information related to promotion information, so as to perform addition or deletion processing on the promotion information in the promotion information base saved by itself, ensuring consistency of the promotion information locally stored in the terminal and the promotion information stored in the server.

It should be noted that, the preset period may be set and adjusted according to practical situation, which is not limited in embodiments of the present disclosure.

The terminal may update the promotion information base saved by itself by receiving addition and deletion information related to promotion information sent from a server, and updating the promotion information base.

When the server detects there is changed promotion information, the server may actively send the addition and deletion information related to promotion information to the terminal. After the terminal receives the addition and deletion information related to promotion information, the terminal updates the promotion information base saved by itself. In practical application, the server may periodically perform detection. Once changed promotion information is detected, the server sends the addition and deletion information related to promotion information to the terminal.

In this way, the consistency of the promotion information stored in the terminal and the promotion information stored in the server is ensured.

At block S150, found promotion information is pushed to the user.

After the terminal finds the promotion information corresponding to the determined information type from the promotion information base saved by itself at block S140, the terminal may directly push the found promotion information to the user.

With the technical solutions provided by embodiments of the present disclosure, the promotion information base is locally stored in the terminal, and after the terminal obtains the user behavior data, the terminal analyzes the user behavior data to obtain the behavior information of the user and/or the behavior access object information of the user, determines the information type of the obtained information, and searches for the promotion information corresponding to the determined information type in the promotion information base stored in the terminal and pushes the found promotion information to the user. In this way, the promotion information pushed to the user is related to the user behavior, and may be of interest to the user, avoiding troubling the user too much due to unrelated promotion information.

It should be noted that, the technical solutions provided by embodiments of the present disclosure are applied to the terminal, which may have following advantages.

Firstly, the terminal can directly search for the promotion information corresponding to the determined information type in the promotion information base stored by itself, and does not need to search in the server, thus ensuring searching is in time.

Secondly, the user behavior data is locally analyzed at the terminal, and it is not necessary to transmit the user behavior data to the server. In a case that the user behavior data is related to the user's privacy, which is not suitable for transmitting in the network, the user behavior data can be analyzed directly at the terminal, protecting the user's privacy.

Then, in a case that data amount of the user behavior data is large, if the user behavior data is transmitted to the server for analyzing, a lot of network flow and server resources may be consumed, while if the data analysis is directly performed at the terminal, network bandwidth and server resource may be saved, reducing the network flow.

In an embodiment of the present disclosure, when there are at least two pieces of found promotion information corresponding to the determined information type, pushing found promotion information to the user may be as follows. In detail, the found promotion information may be pushed in sequence to the user according to an order of priority from high to low, for example, pushing the found promotion information in sequence to the user according to a set time interval, or the found promotion information having a highest priority to the user is pushed to the user.

Priority setting of the promotion information may be realized in the terminal. In detail, the terminal may determine interest tendency of the user according to a result of analyzing the user behavior data, set high priority for promotion information that the user may be interested in, and set low priority for promotion information that the user may not be very interested in. Or, the terminal may set the priority of the promotion information according to update time of the promotion information. For example, the closer to current time the update time of the promotion information is, the higher the priority of the promotion information is, and the further to current time the update time of the promotion information is, the lower the priority of the promotion information is.

Priority setting of the promotion information may be realized in the server. In detail, the server may collect user behavior data from a plurality of terminals, analyze the collected user behavior data to determine interest tendency of most users, set high priority for promotion information that most users may be interested in, and set low priority for promotion information that most users may not be very interested in. After the terminal obtains the promotion information from the server, the terminal may obtain a priority attribute of the promotion information at the same time. Or, the server may set the priority of the promotion information according to update time of the promotion information. For example, the closer to current time the update time of the promotion information is, the higher the priority of the promotion information is, and the further to current time the update time of the promotion information is, the lower the priority of the promotion information is.

Certainly, particular method for setting the priority of the promotion information is not limited to above-described. The priority can be set according to particular case, which is not limited in embodiments of the present disclosure.

It can be understood that, the promotion information having a high priority has a high promotion value, and the promotion information having a high priority is first pushed to the user, which may attract attention of the user to a large extent, thus achieving promotion objective.

In another embodiment of the present disclosure, the method may further include followings.

A viewing operation on the pushed promotion information of the user is received after the found promotion information is pushed to the user. The priority of promotion information in the promotion information base is adjusted according to the number of viewing times of each information type of promotion information.

After the found promotion information is pushed to the user, if the user is interested in the promotion information, the user may click the promotion information and enter a promotional page corresponding to the promotion information, and if the user is not interested in the promotion information, the user may not perform any operation. Therefore, the clicking and viewing operation can represent interest of the user to some extent. The more times the promotion information of a certain information type is viewed, it presents that the user is more interested in the promotion information of the certain information type, and the terminal can adjust the priority of promotion information in the promotion information base saved by itself according to this.

Particular adjusting method may refer to following description.

If the number of viewing times of promotion information of a certain information type is larger than a preset first threshold, the priority of the promotion information of the certain information type is raised by one grade based on the current priority.

If the number of viewing times of promotion information of a certain information type is less than a preset second threshold, the priority of the promotion information of the certain information type is lowered by one grade based on the current priority.

If the number of viewing times of promotion information of a certain information type is not larger than the first threshold, and is not less than the second threshold, the current priority of the promotion information of the certain information type is maintained.

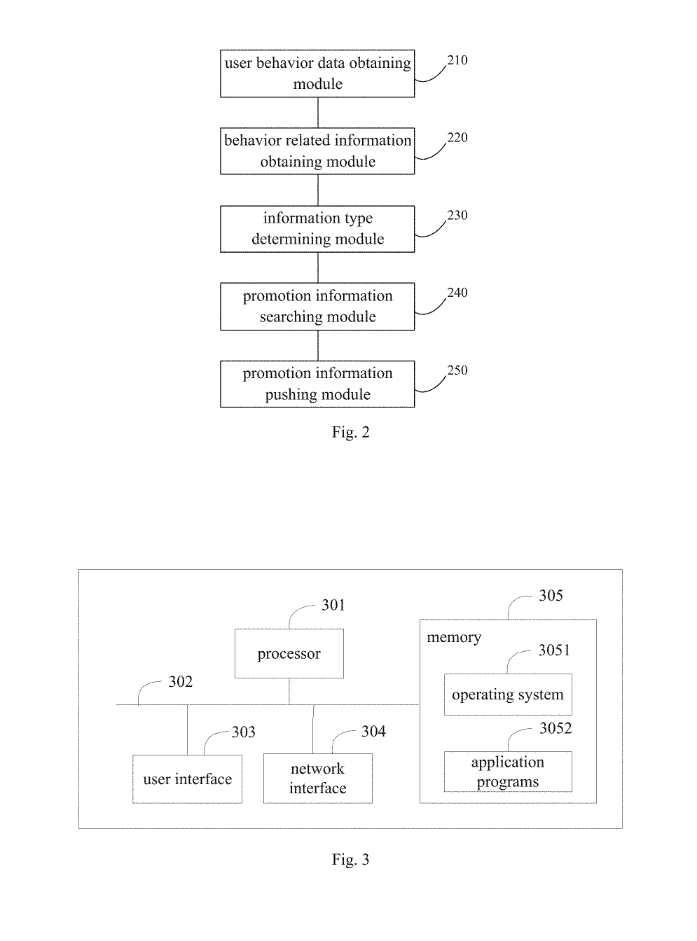

Corresponding to the above method embodiments, embodiments of the present disclosure also provide a device for pushing promotion information applied to a terminal. Referring to FIG. 2, the device may include following modules.

A user behavior data obtaining module 210 is configured to obtain user behavior data of a user using the terminal.

A behavior related information obtaining module 220 is configured to analyze obtained user behavior data, to obtain behavior information of the user and/or behavior access object information of the user.

An information type determining module 230 is configured to determine an information type of obtained behavior information of the user and/or behavior access object information of the user.

A promotion information searching module 240 is configured to search for promotion information corresponding to determined information type in a promotion information base stored in the terminal.

A promotion information pushing module 250 is configured to push found promotion information to the user.

With the device provided by embodiments of the present disclosure, the promotion information base is locally stored in the terminal, and after the terminal obtains the user behavior data, the terminal analyzes the user behavior data to obtain the behavior information of the user and/or the behavior access object information of the user, determines the information type of the obtained information, and searches for the promotion information corresponding to the determined information type in the promotion information base stored in the terminal and pushes the found promotion information to the user. In this way, the promotion information pushed to the user is related to the user behavior, and may be of interest to the user, avoiding troubling the user too much due to unrelated promotion information.

In a particular embodiment of the present disclosure, the promotion information pushing module 250 is configured to: in a case that there are at least two pieces of found promotion information corresponding to the determined information type, push the found promotion information in sequence to the user according to an order of priority from high to low; or, push the found promotion information having a highest priority to the user.

In an embodiment of the present disclosure, the device further includes the following module.

A first promotion information base updating module is configured to send an update request with respect to promotion information to a server according to a preset period; to receive addition and deletion information related to promotion information returned by the server, and to update the promotion information base.

In an embodiment of the present disclosure, the device further includes the following module.

A second promotion information base updating module is configured to receive addition and deletion information related to promotion information sent from a server, and to update the promotion information base.

In an embodiment of the present disclosure, the device further includes the following module.

A priority adjusting module is configured to receive a viewing operation on the pushed promotion information of the user, and to adjust priorities of promotion information in the promotion information base according to the number of viewing times of promotion information of each information type.

FIG. 3 is a block diagram illustrating a terminal according to an embodiment of the present disclosure. The terminal is configured to perform the method for pushing promotion information provided by embodiments of the present disclosure. Referring to FIG. 3, the terminal may include at least one processor 301, such as a CPU, at least one network interface 304 or other user interface 303, a memory 305, and at least one communication bus 302. The communication bus 302 is configured to realize connection and communication between these components. The user interface 303 may alternatively include a USB interface and other standard interface and wired interface. The network interface 304 may alternatively include a Wi-Fi interface and other wireless interface. The memory 305 may include a high speed RAM memory, or may include a non-volatile memory, such as at least one disk memory. The memory 305 may alternatively include at least one storage device located away from the processor 301. As illustrated in FIG. 3, the memory 305, as one kind of computer storage medium, may include an operating system 3051 and application programs 3052.

In some embodiments, the memory 305 stores executable modules or data structure, or their subsets, or their extension sets.

The operating system 3051 includes various system programs configured to implement various basis services and process hardware-based tasks.

The application programs 3052 include various application programs including a setting program of data block parameter of target network data, a dividing program of a target data block, a comparing program of the target data block and data block in a database, and a deleting program of the target data block, and the like, and are configured to implement various application services.

In detail, the processor 301 is configured to call programs stored in the memory 305 to perform following operations:

obtaining user behavior data of a user using the terminal;

analyzing obtained user behavior data, to obtain behavior information of the user and/or behavior access object information of the user;

determining an information type of obtained behavior information of the user and/or behavior access object information of the user;

searching for promotion information corresponding to determined information type in a promotion information base stored in the terminal;

pushing found promotion information to the user.

In another embodiment of the present disclosure, when there are at least two pieces of found promotion information corresponding to the determined information type, pushing found promotion information to the user may include: pushing the found promotion information in sequence to the user according to an order of priority from high to low; or, pushing the found promotion information having a highest priority to the user.

In another embodiment of the present disclosure, the processor 301 is further configured to perform following operations: sending an update request with respect to promotion information to a server according to a preset period; and receiving addition and deletion information related to promotion information returned by the server, and updating the promotion information base.

In another embodiment of the present disclosure, the processor 301 is further configured to perform following operations: receiving addition and deletion information related to promotion information sent from a server, and updating the promotion information base.

In another embodiment of the present disclosure, after pushing found promotion information to the user, the processor 301 is further configured to perform following operations: receiving a viewing operation on the pushed promotion information of the user; and adjusting priorities of promotion information in the promotion information base according to the number of viewing times of promotion information of each information type.

With this embodiment, the promotion information base is locally stored in the terminal, and after the terminal obtains the user behavior data, the terminal analyzes the user behavior data to obtain the behavior information of the user and/or the behavior access object information of the user, determines the information type of the obtained information, and searches for the promotion information corresponding to the determined information type in the promotion information base stored in the terminal and pushes the found promotion information to the user. In this way, the promotion information pushed to the user is related to the user behavior, and may be of interest to the user, avoiding troubling the user too much due to unrelated promotion information.

It should be noted that relationship terms such as first and second are only used herein to distinguish an entity or operation from another entity or operation, and it is not necessarily required or implied that there are any actual relationship or order of this kind between those entities and operations. Moreover, terms such as “comprise”, “comprising” and any other variants are intended to cover non-exclusive contains, so that the processes, methods, articles or devices including a series of elements not only include those elements but also include other elements that are not listed definitely, or also include the elements inherent in the processes, methods, articles or devices. In the case of no more restrictions, the elements defined by the statement ‘comprise one . . . ’ do not exclude that other same elements also exist in the processes, methods, articles or devices including the elements.

It should be noted that each embodiment in the specification is described in a relevant manner. For same or similar parts in the embodiments, reference may be made to each other. What is different from other embodiments is emphasized in each embodiment. In particular, for the apparatus embodiment, because it is basically similar to the method embodiment, the apparatus embodiment is described simply, and for a relevant part thereof, reference may be made to part of the description of the method embodiment.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases such as “in some embodiments,” “in one embodiment”, “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, it will be apparent to those skilled in the art that different embodiments or examples described in this specification, as well as features in different embodiments or examples, may be combined and combined without contradictory circumstances.

Those skilled in the art can combine different embodiments and the features in different embodiments described in this specification. The modules or units in all embodiments of the present disclosure may be implemented by a generally used integrated circuit, such as a CPU (central processing unit), or by ASIC (application specific integrated circuit).

The steps in the method of all embodiments of the present disclosure may be performed order adjusting, and be combined and deleted according to actual needs; modules or units in the device of all embodiments of the present disclosure may be combined, separated and deleted according to actual needs.

It will be understood that, the flow chart or any process or method described herein in other manners may represent a module, segment, or portion of code that comprises one or more executable instructions to implement the specified logic function(s) or that comprises one or more executable instructions of the steps of the progress. In addition, it should be understood by those skilled in the art to which the embodiments of the present disclosure belong that, the scope of preferred embodiments of the present disclosure includes other implementations in which the functions may be performed in an order other than order shown or discussed, including in a substantially simultaneous manner or in a reverse order with the functions involved, As will be understood by those skilled in the art to which this invention pertains.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It can be understood by those skilled in the art that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The above-mentioned storage medium may be a read-only memory, a magnetic disk, an optical disks, etc. Although embodiments of the present disclosure have been shown and described, it would be appreciated by those skilled in the art that the above embodiments are explanatory and cannot be construed to limit the present disclosure, and changes, alternatives, and modifications can be made in the embodiments without departing from scope of the present disclosure.

What the above discloses is merely preferable embodiments of the present disclosure, and certainly cannot be construed to limit the scope of the present disclosure. All or part of flows of realizing above embodiments can be understood by those skilled in the art, and equivalent changes made according to the claims of the present disclosure is still within the scope of the present disclosure.

1. A method for pushing promotion information, applied to a terminal, and comprising:
obtaining user behavior data of a user using the terminal;
analyzing obtained user behavior data, to obtain behavior information of the user and/or behavior access object information of the user;
determining an information type of obtained behavior information of the user and/or behavior access object information of the user;
searching for promotion information corresponding to determined information type in a promotion information base stored in the terminal; and
pushing found promotion information to the user.

2. The method according to claim 1, when there are at least two pieces of found promotion information corresponding to the determined information type, pushing found promotion information to the user comprises:
pushing the found promotion information in sequence to the user according to an order of priority from high to low;
or,
pushing the found promotion information having a highest priority to the user.

3. The method according to claim 1, further comprising:
sending an update request with respect to promotion information to a server according to a preset period; and
receiving addition and deletion information related to promotion information returned by the server, and updating the promotion information base.

4. The method according to claim 1, further comprising:
receiving addition and deletion information related to promotion information sent from a server, and updating the promotion information base.

5. The method according to claim 1, after pushing found promotion information to the user, further comprising:
receiving a viewing operation on the pushed promotion information of the user; and
adjusting priorities of promotion information in the promotion information base according to the number of viewing times of the pushed promotion information.

6. A device for pushing promotion information, applied to a terminal, and comprising:
a processor; and
a memory, configured to store instructions executable by the processor;
wherein the processor is configured to read executable instructions stored in the memory, so as to:
obtain user behavior data of a user using the terminal;
analyze obtained user behavior data, to obtain behavior information of the user and/or behavior access object information of the user;
determine an information type of obtained behavior information of the user and/or behavior access object information of the user;
search for promotion information corresponding to determined information type in a promotion information base stored in the terminal; and
push found promotion information to the user.

7. The device according to claim 6, wherein the processor is configured to:
in a case that there are at least two pieces of found promotion information corresponding to the determined information type, push the found promotion information in sequence to the user according to an order of priority from high to low; or, push the found promotion information having a highest priority to the user.

8. The device according to claim 6, wherein the processor is further configured to:
send an update request with respect to promotion information to a server according to a preset period; to receive addition and deletion information related to promotion information returned by the server, and to update the promotion information base.

9. The device according to claim 6, wherein the processor is further configured to:
receive addition and deletion information related to promotion information sent from a server, and to update the promotion information base.

10. The device according to claim 6, wherein the processor is further configured to:
receive a viewing operation on the pushed promotion information of the user, and to adjust priorities of promotion information in the promotion information base according to the number of viewing times of the pushed promotion information.

11. (canceled)

12. A non-transitory computer-readable storage medium having stored therein instructions that, when executed by a processor of a terminal, cause the terminal to perform a method for pushing promotion information, the method comprising:
obtaining user behavior data of a user using the terminal;
analyzing obtained user behavior data, to obtain behavior information of the user and/or behavior access object information of the user;
determining an information type of obtained behavior information of the user and/or behavior access object information of the user;
searching for promotion information corresponding to determined information type in a promotion information base stored in the terminal; and
pushing found promotion information to the user.

13. (canceled)

14. The method according to claim 5, wherein adjusting priorities of promotion information in the promotion information base according to the number of viewing times of the pushed promotion information comprises:
when the number of viewing times of the pushed promotion information is greater than a first preset threshold, increasing the priorities of promotion information having a same information type as the pushed promotion information in the promotion information base by one grade;
when the number viewing times of the pushed promotion information is less than a second preset threshold, decreasing the priorities of promotion information having a same information type as the pushed promotion information in the promotion information base by one grade;
when the number of viewing times of the pushed promotion information is not greater than the first preset threshold and not less than the second preset threshold, keeping the priorities of promotion information having a same information type as the pushed promotion information in the promotion information base unchanged.

15. The device according to claim 10, wherein the processor is configured to:
when the number of viewing times of the pushed promotion information is greater than a first preset threshold, increase the priorities of promotion information having a same information type as the pushed promotion information in the promotion information base by one grade;
when the number viewing times of the pushed promotion information is less than a second preset threshold, decrease the priorities of promotion information having a same information type as the pushed promotion information in the promotion information base by one grade;
when the number of viewing times of the pushed promotion information is not greater than the first preset threshold and not less than the second preset threshold, keep the priorities of promotion information having a same information type as the pushed promotion information in the promotion information base unchanged.

16. The storage medium according to claim 12, wherein when there are at least two pieces of found promotion information corresponding to the determined information type, pushing found promotion information to the user comprises:
pushing the found promotion information in sequence to the user according to an order of priority from high to low;
or,
pushing the found promotion information having a highest priority to the user.

17. The storage medium according to claim 12, wherein the method further comprises:
sending an update request with respect to promotion information to a server according to a preset period; and
receiving addition and deletion information related to promotion information returned by the server, and updating the promotion information base.

18. The storage medium according to claim 12, wherein the method further comprises:
receiving addition and deletion information related to promotion information sent from a server, and updating the promotion information base.

19. The storage medium according to claim 12, wherein the method further comprises:
receiving a viewing operation on the pushed promotion information of the user; and
adjusting priorities of promotion information in the promotion information base according to the number of viewing times of the pushed promotion information.

20. The storage medium according to claim 19, wherein adjusting priorities of promotion information in the promotion information base according to the number of viewing times of the pushed promotion information comprises:
when the number of viewing times of the pushed promotion information is greater than a first preset threshold, increasing the priorities of promotion information having a same information type as the pushed promotion information in the promotion information base by one grade;
when the number viewing times of the pushed promotion information is less than a second preset threshold, decreasing the priorities of promotion information having a same information type as the pushed promotion information in the promotion information base by one grade;
when the number of viewing times of the pushed promotion information is not greater than the first preset threshold and not less than the second preset threshold, keeping the priorities of promotion information having a same information type as the pushed promotion information in the promotion information base unchanged.
